(19) United States
(12) Patent Application Publication
(10) Pub. No.: US 2012/0231125 A1
(43) Pub. Date: Sep. 13, 2012

(54) METHOD OF PRODUCING A PACKAGED EDIBLE

(75) Inventor: Rafi OREL, Zur Moshe (IL)

(73) Assignee: DOROT - GARLIC & HERBS AGRICULTURAL COOPERATION LTD., D.N. Hof Ashkelon (IL)

(21) Appl. No.: 13/044,223

(22) Filed: Mar. 9, 2011

(51) Int. Cl. B65D 85/00; A23L 3/36; A23L 3/3454

(52) U.S. Cl. 426/115; 426/394; 426/393

(57) ABSTRACT

A packaged edible including a generally cylindrical body of a foodstuff mixed with a binder in a generally solid form and arranged about a longitudinal axis and a dispensing package generally enclosing the generally cylindrical body of a foodstuff mixed with a binder in a generally solid form, the dispensing package including a first hand engageable enclosure portion generally surrounding the generally cylindrical body of a foodstuff mixed with a binder in a generally solid form, a shaving element arranged to rotate about the longitudinal axis and a second hand engageable element arranged for manual rotation about the longitudinal axis and arranged to rotate the shaving element about the longitudinal axis in operative engagement with the generally cylindrical body of a foodstuff mixed with a binder in a generally solid form for shaving a surface thereof.

### FIELD OF THE INVENTION

The present invention relates to preserved foodstuffs and methods and apparatus for producing and dispensing preserved foodstuffs.

### BACKGROUND OF THE INVENTION

The following publications are believed to represent the current state of the art:

U.S. Pat. Nos. 6,663,031; 6,491,244 and 6,247,661.

### SUMMARY OF THE INVENTION

The present invention seeks to provide improved preserved foodstuffs and improved methods and apparatus for producing and dispensing preserved foodstuffs.

There is thus provided in accordance with a preferred embodiment of the present invention a packaged edible including a generally cylindrical body of a foodstuff mixed with a binder in a generally solid form and arranged about a longitudinal axis and a dispensing package generally enclosing the generally cylindrical body of a foodstuff mixed with a binder in a generally solid form, the dispensing package including a first hand engageable enclosure portion generally surrounding the generally cylindrical body of a foodstuff mixed with a binder in a generally solid form, a shaving element arranged to rotate about the longitudinal axis and a second hand engageable element arranged for manual rotation about the longitudinal axis and arranged to rotate the shaving element about the longitudinal axis in operative engagement with the generally cylindrical body of a foodstuff mixed with a binder in a generally solid form for shaving a surface thereof.

Preferably, the dispensing package also includes a piston assembly including an axial screw element and a piston, the axial screw element being rotated by rotation of the second hand engageable element about the longitudinal axis and thereby producing axial movement of the piston along the longitudinal axis to force the generally cylindrical body of a foodstuff mixed with a binder in a generally solid form into the operative engagement with the shaving element.

In accordance with a preferred embodiment of the present invention the foodstuff mixed with a binder in a generally solid form includes at least one of a vegetable, a spice and an herb. Additionally or alternatively, the foodstuff mixed with a binder in a generally solid form includes olive oil.

Preferably, the foodstuff mixed with a binder in a generally solid form includes a foodstuff mixed with a binder in a frozen state.

There is also provided in accordance with another preferred embodiment of the present invention a method of producing a packaged edible including forming particles of a foodstuff into a generally cylindrical body of a foodstuff mixed with a binder in a generally solid form and arranged about a longitudinal axis and enclosing the generally cylindrical body of a foodstuff mixed with a binder in a generally solid form in a dispensing package including a first hand engageable enclosure portion generally surrounding the generally cylindrical body of a foodstuff mixed with a binder in a generally solid form, a shaving element arranged to rotate about the longitudinal axis and a second hand engageable element arranged for manual rotation about the longitudinal axis and arranged to rotate the shaving element about said longitudinal axis in operative engagement with the generally cylindrical body of a foodstuff mixed with a binder in a generally solid form for shaving a surface thereof.

Preferably, the forming and the enclosing includes filling the dispensing package with a foodstuff mixed with a binder in a non-solid form and solidifying the foodstuff mixed with a binder in a non-solid form. Additionally, the solidifying includes freezing the foodstuff mixed with a binder in a non-solid form.

In accordance with a preferred embodiment of the present invention the method also includes, prior to the forming, providing unprocessed foodstuffs, washing the foodstuffs, thereafter at least one of chopping the foodstuffs, grinding the foodstuffs and milling the foodstuffs and thereafter mixing the foodstuffs with a preserving binder. Additionally, the foodstuffs include at least one of a vegetable, a spice and an herb. Additionally or alternatively, the preserving binder includes olive oil.

There is further provided in accordance with yet another preferred embodiment of the present invention a method of producing a packaged edible including mixing particles of at least one foodstuff with a binder in a generally liquid form to produce a generally liquid mixture, inserting the generally liquid mixture in a dispensing package arranged about a longitudinal axis, the dispensing package including a first hand engageable enclosure portion generally enclosing the generally liquid mixture, a shaving element arranged to rotate about the longitudinal axis and a second hand engageable element arranged for manual rotation about the longitudinal axis and arranged to rotate the shaving element about the longitudinal axis and solidifying the generally liquid mixture to produce a generally solid mixture, the shaving element being arranged to shave a surface of the generally solid mixture when rotated in operative engagement with the generally solid mixture.

Preferably, the solidifying includes freezing the generally liquid mixture.

In accordance with a preferred embodiment of the present invention the method also includes, prior to the mixing, providing unprocessed foodstuffs, washing the foodstuffs and thereafter at least one of chopping the foodstuffs, grinding the foodstuffs and milling the foodstuffs.

Preferably, the at least one foodstuff includes at least one of a vegetable, a spice and an herb. Additionally or alternatively, the preserving binder includes olive oil.

There is yet further provided in accordance with still another preferred embodiment of the present invention a method of producing a packaged edible including mixing particles of at least one foodstuff with a binder in a generally liquid form to produce a generally liquid mixture inserting the generally liquid mixture in a first hand engageable enclosure portion of a dispensing package arranged about a longitudinal axis, solidifying the generally liquid mixture to produce a generally solid mixture, placing a shaving element arranged to rotate about the longitudinal axis onto the first hand engageable enclosure portion and placing a second hand engageable element arranged for manual rotation about the longitudinal axis and arranged to rotate the shaving element about the longitudinal axis, the shaving element being arranged to shave a surface of the generally solid mixture when rotated in operative engagement with the generally solid mixture.

### BRIEF DESCRIPTION OF THE DRAWINGS

The present invention will be understood and appreciated more fully from the following detailed description, taken in conjunction with the drawings in which:

FIG. 1 is a simplified pictorial illustration of a system for producing and packaging preserved foodstuffs, constructed and operative in accordance with a preferred embodiment of the present invention;

FIGS. 2A and 2B are simplified respective downward-facing and upward-facing exploded view pictorial view illustrations of a preserved foodstuff in a dispensing package constructed and operative in accordance with a preferred embodiment of the present invention;

FIGS. 3A and 3B are simplified respective upward facing and downward facing illustrations of a cover portion of the dispensing package of FIGS. 2A and 2B;

FIGS. 4A, 4B, 4C and 4D are simplified respective upward facing, downward facing, axial sectional and circumferential sectional illustrations of a manually engageable enclosure portion of the dispensing package of FIGS. 2A and 2B;

FIGS. 5A, 5B and 5C are simplified respective upward facing, downward facing and partially sectional downward facing illustrations of a piston element, forming part of the dispensing package of FIGS. 2A and 2B;

FIGS. 6A, 6B and 6C are simplified respective upward facing, downward facing and partially sectional downward facing illustrations of a shaving element, forming part of the dispensing package of FIGS. 2A and 2B;

FIGS. 7A and 7B are respective pictorial and sectional illustrations of an axial screw element forming part of the dispensing package of FIGS. 2A and 2B;

FIGS. 8A and 8B are simplified sectional illustrations of the preserved foodstuff in a dispensing package of FIGS. 2A and 2B in a pre-dispensing stage and a dispensing stage, respectively; and

FIG. 9 is a simplified pictorial illustration of a system for producing and packaging preserved foodstuffs, constructed and operative in accordance with another preferred embodiment of the present invention.

### DETAILED DESCRIPTION OF A PREFERRED EMBODIMENT

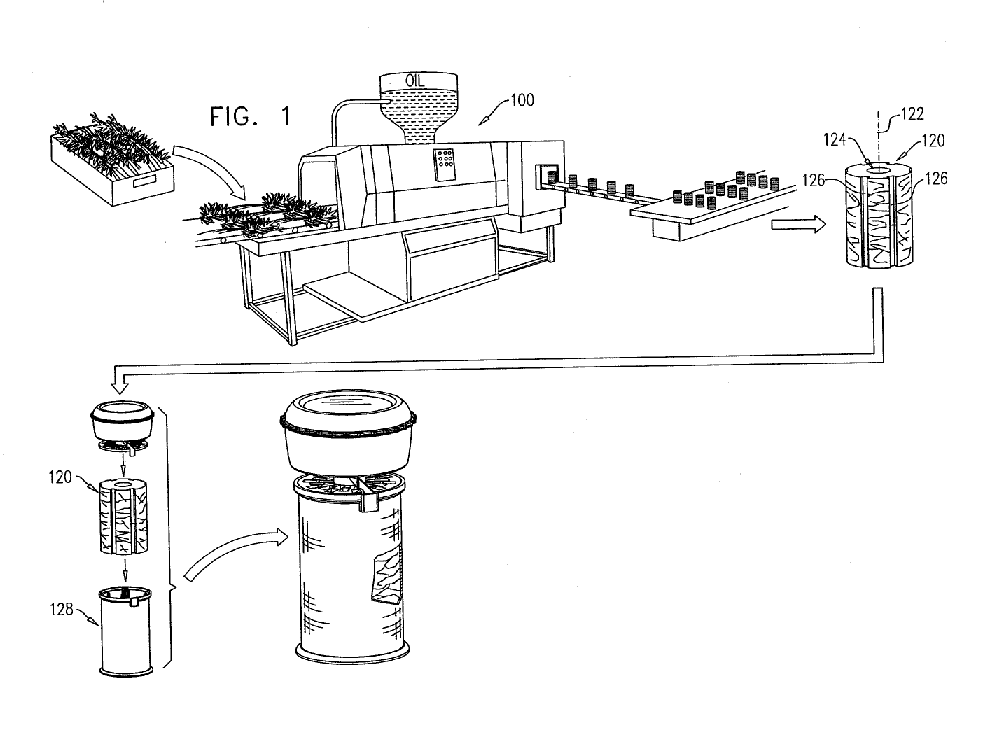

Reference is now made to FIG. 1, which is a simplified, pictorial illustration of a system for producing and packaging preserved foodstuffs, constructed and operative in accordance with a preferred embodiment of the present invention. As seen in FIG. 1, foodstuffs, such as vegetables, for example, onion, garlic, and/or pepper, spices and/or herbs, are supplied to a processing machine 100 which preferably includes the following operational stages:

a washing stage in which the foodstuffs are washed;

a chopping, grinding or milling stage in which the washed foodstuffs are chopped, ground or milled into pieces of desired size;

a mixing stage in which the chopped, ground or milled foodstuffs are mixed in a preserving binder, such as olive oil, typically when in it is in a liquid state; and

a solidifying stage in which the mixed foodstuffs and preserving binder are solidified in a desired shape.

The solidifying stage may include a freezing stage wherein the mixed foodstuffs and preserving binder are solidified. This is appropriate when olive oil is used as a preserving binder. Alternatively, the solidifying stage may include a refrigeration stage wherein the mixed foodstuffs and preserving binder are solidified.

As a further alternative, other suitable binders may be employed. Such binders may be solid at room temperature or at a lower, non-freezing temperature.

Examples of other useful binders include fractionated vegetable oils, vegetable oils, mixtures of fractionated vegetable oils and water, and mixtures of vegetable oils and water.

It is appreciated that the foodstuffs may be provided in a fresh state or a dried state.

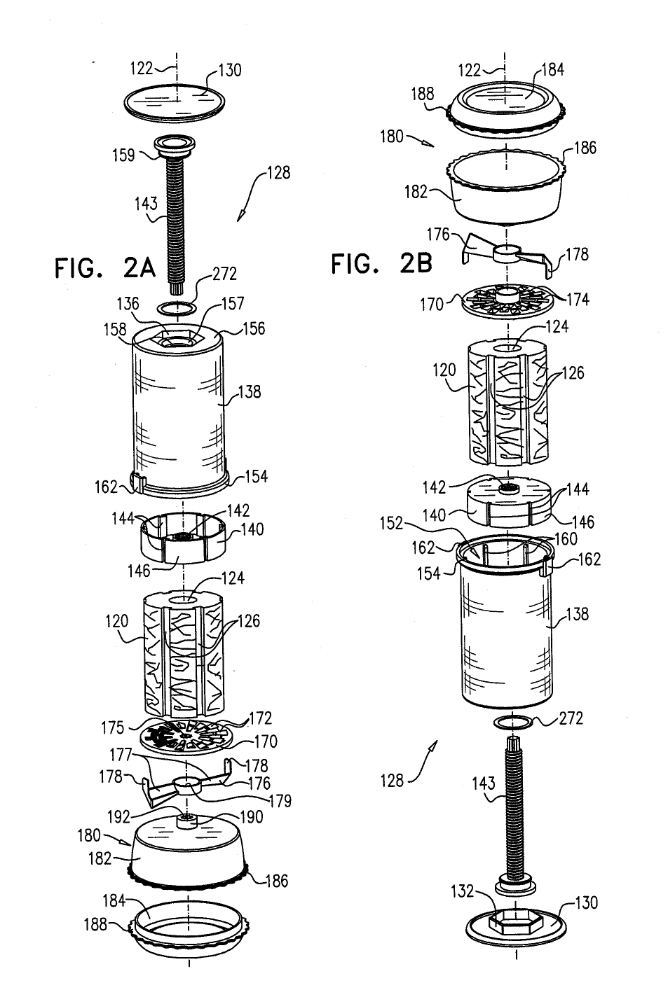

As seen in FIG. 1, the desired shape is preferably that of a cylinder 120 arranged about a longitudinal axis 122 having a central axial bore 124 and having axially extending slots 126 formed in a peripheral surface thereof. Preferably the mixed foodstuffs and preserving binder in the form of cylinder 120 are packaged in a generally cylindrical dispensing package 128, which is described hereinbelow in reference to FIGS. 2A-7B.

Reference is now made to FIGS. 2A and 2B, which are simplified respective downward-facing and upward-facing exploded, pictorial view illustrations of a preserved foodstuff in dispensing package 128, constructed and operative in accordance with a preferred embodiment of the present invention.

As seen in FIGS. 2A and 2B, dispensing package 128 comprises a top cover portion 130, typically in the form of a disc and having a central enclosure portion engagement area 132. Engagement area 132 typically engages a correspondingly configured socket 136 formed in a manually engageable, generally cylindrical enclosure portion 138.

A piston element 140 is located interiorly of manually engageable, generally cylindrical enclosure portion 138 and is formed with an internally threaded portion 142 for being driven longitudinally along axis 122 by rotation of an axial screw element 143. Piston element 140 is formed with axial slots 144 on an outer cylindrical surface 146 thereof.

Generally cylindrical enclosure portion 138 has an open end 152 surrounded by a flange 154 and a generally closed end 156, having socket 136 formed therein, which accommodates engagement area 132 of cover portion 130, and an inwardly facing annular portion 157 defining an annular recess 158 which accommodates a top portion 159 of axial screw element 143.

The interior of enclosure portion 138 is preferably formed with axially extending protrusions 160 which preferably engage correspondingly located slots 144 in piston element 140 for preventing rotation of piston element 140 relative to enclosure portion 138, when piston element 140 is driven by rotation of axial screw element 143.

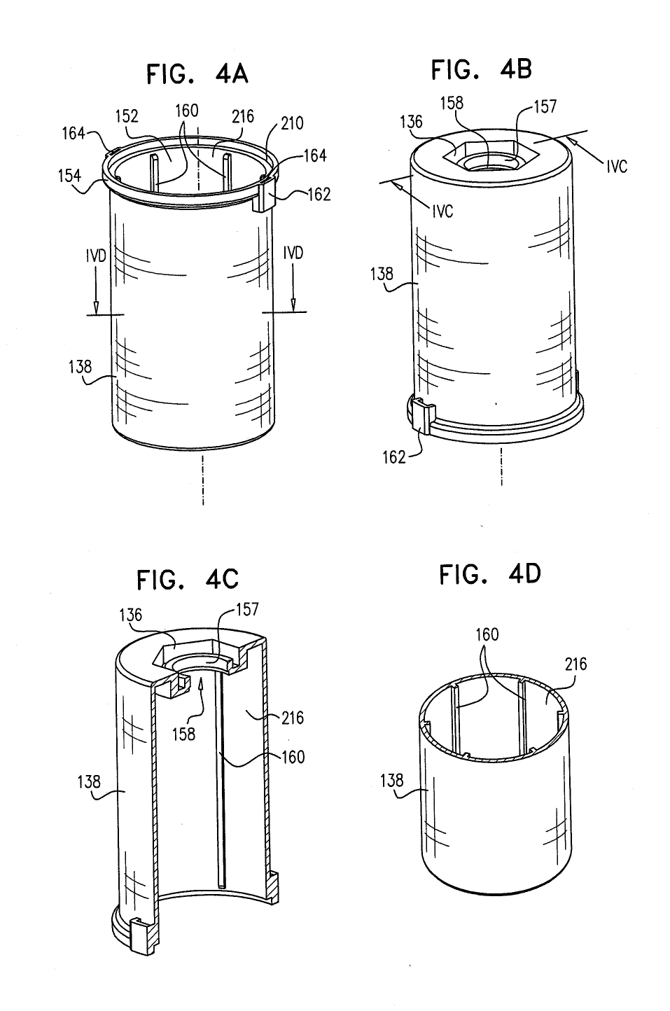

Enclosure portion 138 also includes cutter engagement portions 162 defining cutter retaining apertures 164 (FIG. 4A) formed in flange 154.

Cylinder 120 of mixed foodstuffs and preserving binder is located within enclosure portion 138 below piston element 140, such that axial screw element 143 extends through bore 124. Protrusions 160 also engage slots 126 in cylinder 120 and thus prevent rotation of cylinder 120 relative thereto about axis 122.

A shaving element 170 is provided in operative engagement with a bottom surface of cylinder 120 of mixed foodstuffs and preserving binder, which is forced thereagainst by piston element 140. Shaving element 170 is typically in the form of a disc having formed thereon a multiplicity of blades 172 and adjacent apertures 174. Shaving element 170 is configured for seating in flange 152 and has a screw engagement aperture 175 for engaging axial screw element 143.

Dispensing package 128 also includes a cutting element 176, including cutting edges 177 which engage a downward facing surface of shaving element 170 to assist shaved portions of mixed foodstuffs and preserving binder to fall from shaver element 170. Cutting element 176 also includes tabs 178 which are inserted into cutter retaining apertures 164 (FIG. 4A) of enclosure portion 138 to engage cutting element 176 and thus prevent rotation of cutting element 176 relative to enclosure portion 138 about axis 122. Cutting element 176 also includes a cylindrical portion 179 which aligns cutting element 176 and shaving element 170.

Dispensing package 128 also includes a user-hand engageable screw rotation portion 180, which includes a screw engagement portion 182 and an enclosing portion 184, formed with respective user-engagement portions 186 and 188. Screw engagement portion 182 is formed with a screw engagement protrusion 190 defining a screw engagement aperture 192.

Screw rotation portion 180 is engaged by one hand of a user, when the user's other hand is grasping enclosure portion 138. Rotation of screw rotation portion 180 by the user, relative to enclosure portion 138, provides rotational movement of axial screw element 143 about axis 122, which in turn produces axial driving of piston element 140 along longitudinal axis 122 and rotational motion of shaving element 170 about longitudinal axis 122 in operative engagement with a bottom surface of cylinder 120 of mixed foodstuffs and preserving binder, which is forced thereagainst by piston element 140. The rotational motion of shaving element 170 about longitudinal axis 122 causes portions of the mixed foodstuffs and preserving binder to be separated from cylinder 120 where they are then cut by cutting edges 177 of cutting portion 176 and are dispensed from dispenser package 128.

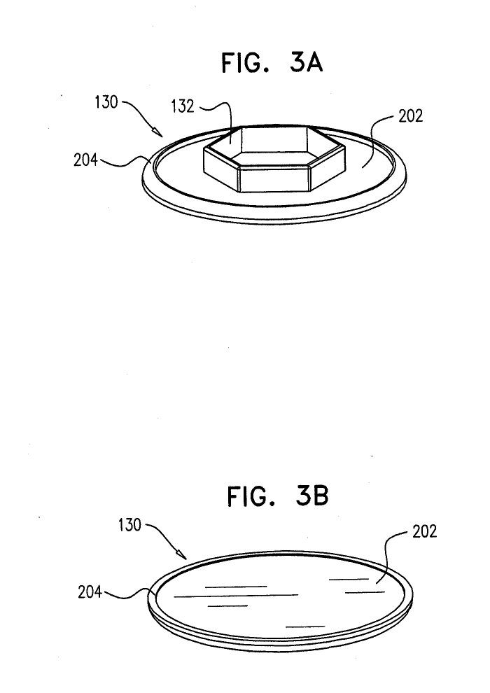

Reference is now made to FIGS. 3A and 3B, which are simplified respective upward facing and downward facing illustrations of the top cover portion 130 of the dispensing package of FIGS. 2A and 2B. As seen in FIGS. 3A-3B, top cover portion 130 includes a disc portion 202 surrounded by a rim 204. Central enclosure portion engagement area 132 extends downwardly and is configured to engage socket 136 in enclosure portion 138.

Reference is now made to FIGS. 4A, 4B, 4C and 4D, which are simplified respective upward facing, downward facing, axial sectional and circumferential sectional illustrations of manually engageable enclosure portion 138 of the dispensing package of FIGS. 2A and 2B. As seen in FIGS. 4A-4D, open end 152 and flange 154 of enclosure portion 138 together define a circumferential shoulder 210. Generally closed end 156 preferably includes socket 136 formed therein and inwardly facing annular portion 157. Axially extending protrusions 160 are distributed along the circumference of an interior surface 216 of enclosure portion 138.

Enclosure portion 138 also includes cutter engagement portions 162 defining cutter retaining apertures 164 formed in flange 154.

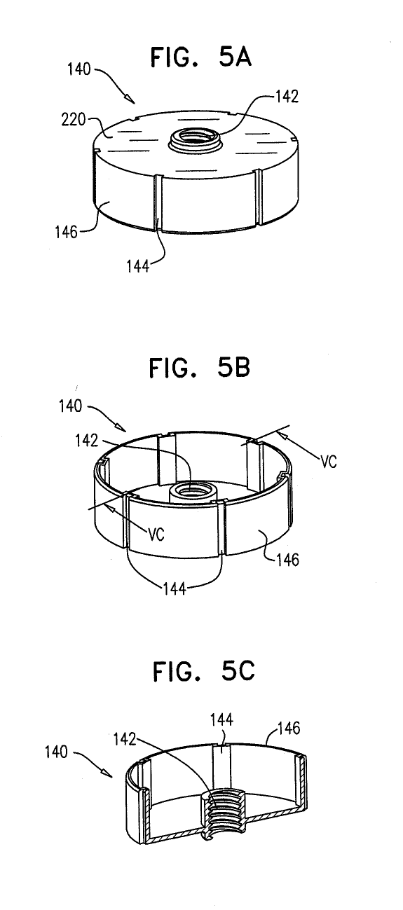

Reference is now made to FIGS. 5A, 5B and 5C, which are simplified respective upward facing, downward facing and partially sectional downward facing illustrations of piston element 140 of the dispensing package of FIGS. 2A and 2B. Piston element 140 includes a radially extending disc portion 220 at the center of which is provided internally threaded portion 142. Outer cylindrical surface 146 is formed at the periphery of disc portion 220. Axial slots 144 are distributed about the circumference of outer cylindrical surface 146 with the same spacing as axially extending protrusions 160 at the inner surface 216 of enclosure portion 138.

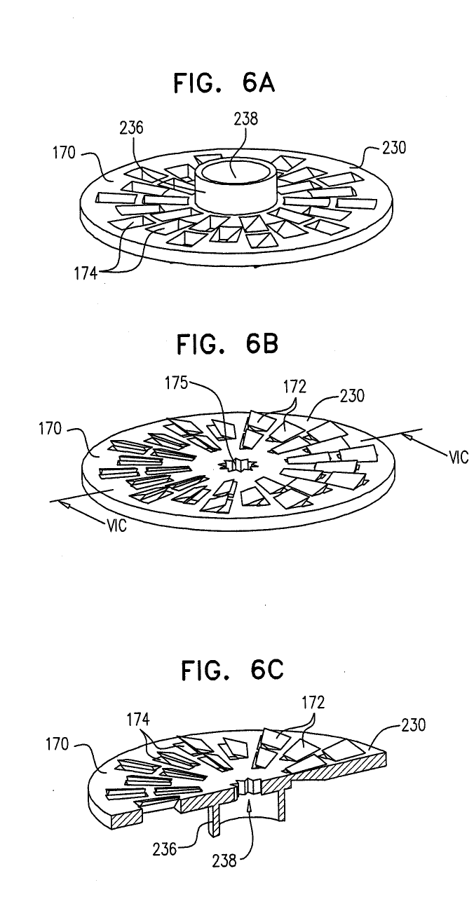

Reference is now made to FIGS. 6A, 6B and 6C, which are simplified respective upward facing, downward facing and partially sectional downward facing illustrations of shaving element 170 of the dispensing package of FIGS. 2A and 2B. Shaving element 170 includes a generally disc-like portion 230 having formed thereon blades 172 and apertures 174.

When rotated in operative engagement with a bottom surface of cylinder 120 of mixed foodstuffs and preserving binder, which is forced thereagainst by piston element 140, blades 172 of shaving element 170 scrape off portions of the mixed foodstuff and preserving binder from cylinder 120. These portions, or shavings, fall through apertures 174 and are cut by cutting edges 177 of cutting element 176 as shaving element 170 rotates relative thereto.

Disk-like portion 230 is formed with screw engagement aperture 175 at the center thereof for engaging axial screw element 143. At the center on the underside of disc-like portion 230 there is formed a generally cylindrical portion 236 defining a hollow bore 238.

It is noted that when dispensing package 128 is assembled disk-like portion 230 engages circumferential shoulder 210 (FIG. 4A).

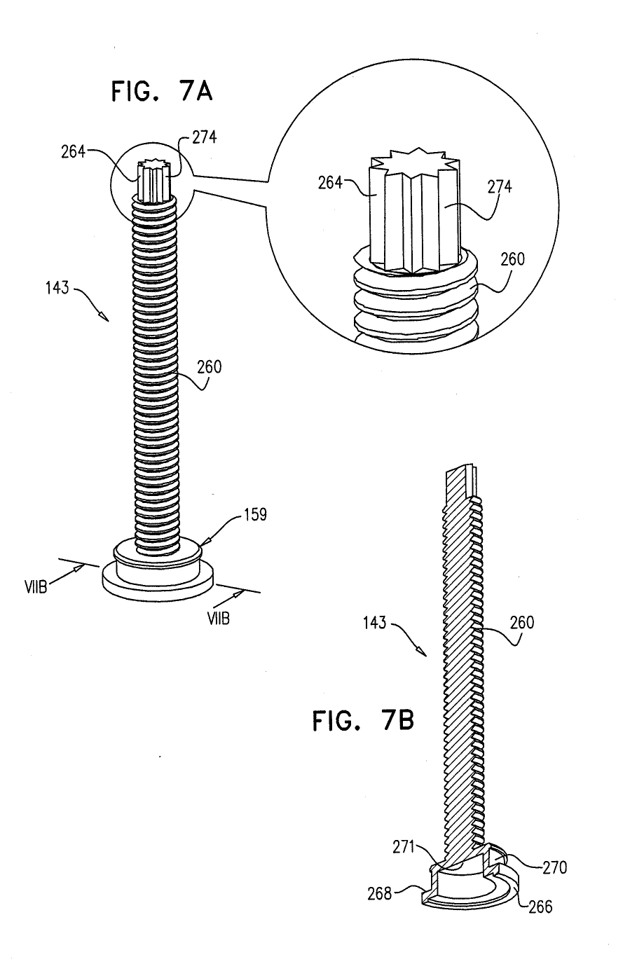

Reference is now made to FIGS. 7A and 7B, which illustrate axial screw element 143 of the dispensing package 128 of FIGS. 2A and 2B. As seen in FIGS. 7A and 7B, axial screw element 143 includes a threaded main portion 260, top portion 159 and a bottom portion 264.

Top portion 159 preferably includes an outer flange 266 extending upwardly from an annular portion 268, which extends outwardly from a cylindrical portion 270. Cylindrical portion 270 preferably extends upwardly from a disc-like portion 271. It is noted that when dispensing package 128 is assembled, flange 266 and annular portion 268 are located in engagement area 132 of top cover portion 130 and cylindrical portion 270 is located in annular recess 158, allowing rotational movement of screw element 143. An O-ring 272 (FIGS. 2A-2B) is preferably provided between annular portion 268 and annular portion 157.

Bottom portion 264 axial screw element 143 preferably comprises an engagement portion 274, lying above threaded main portion 260. Engagement portion 274 preferably engages screw engagement aperture 175 of shaving element 170 (FIGS. 6A-6C), to provide rotational motion to shaving element 170, and screw engagement aperture 192 of screw engagement portion 182.

It is noted that when dispensing package 128 is assembled, axial screw element 143 provides axial displacement of piston 140, which thereby displaces cylinder 120, along axis 122 and also provides rotational movement of shaving element 170 about axis 122 relative to enclosure portion 138 when screw element 143 is rotated about axis 122 by a user rotatingly engaging screw rotation portion 180 in one hand while the user's other hand is holding enclosure portion 138.

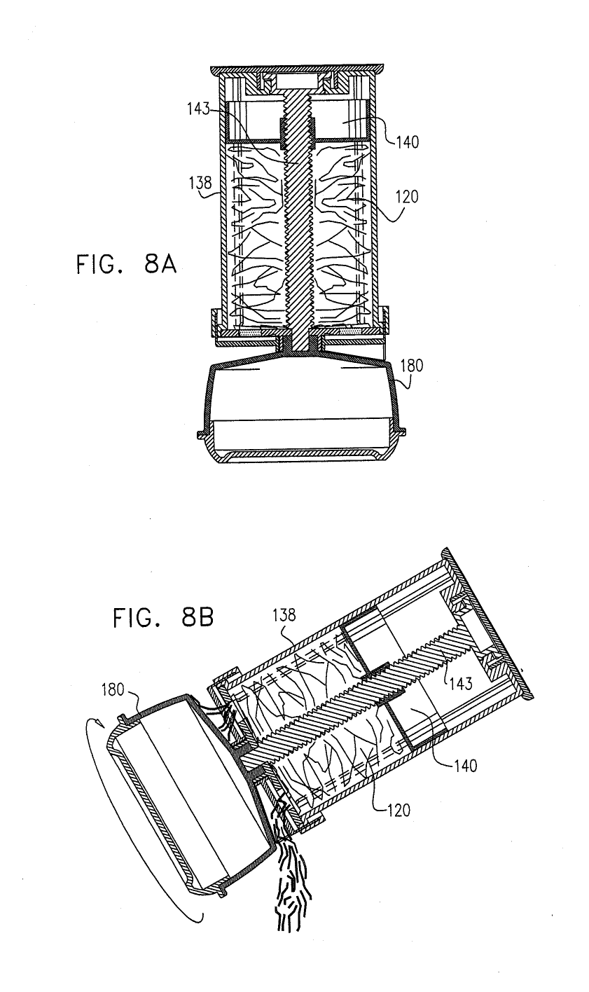

Reference is now made to FIGS. 8A and 8B, which are simplified sectional illustrations of the preserved foodstuff in a dispensing package of FIGS. 2A and 2B in a pre-dispensing stage and a dispensing stage, respectively. It is seen that manually rotating screw rotation portion 180 about axis 122, relative to enclosure portion 138, produces axial movement of piston element 140, which causes piston element 140 to push cylinder 120 downward into engagement with shaving element 170, while also producing rotational movement of shaving element 170 relative to cylinder 120 and relative to cutting element 176 causing portions of cylinder 120 to be shaved off from the bottom thereof. Shaved portions of cylinder 120 engage cutting edges 177 of cutting element 176 and are separated for dispensing, as seen in FIG. 8B.

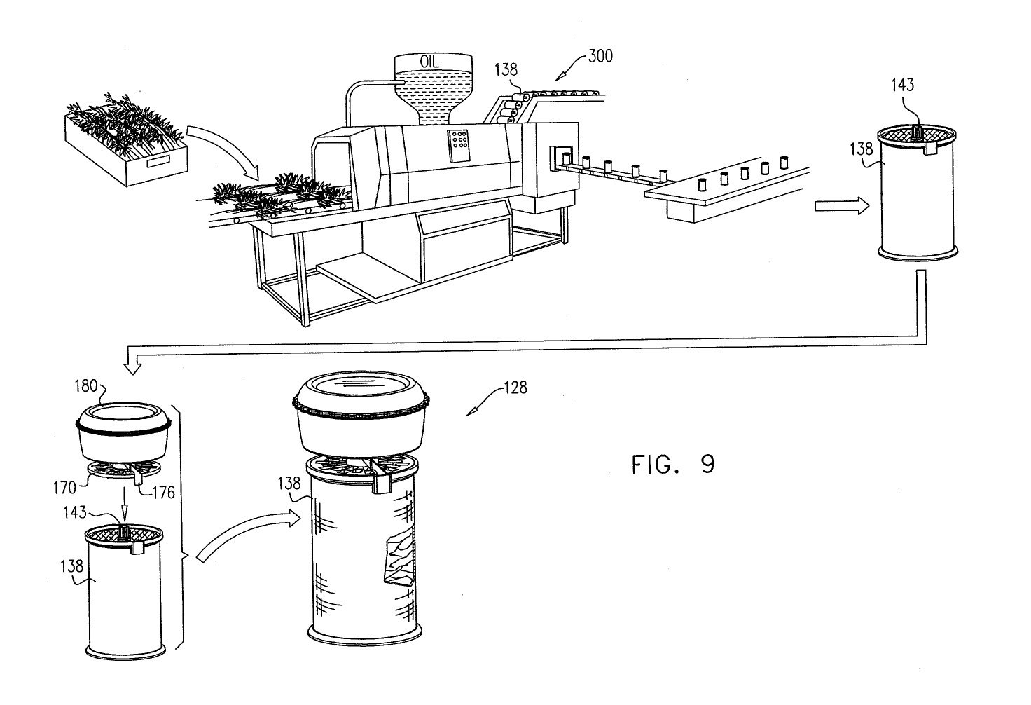

Reference is now made to FIG. 9, which is a simplified, pictorial illustration of a system for producing and packaging preserved foodstuffs, constructed and operative in accordance with another preferred embodiment of the present invention. The system of FIG. 9 is similar to the system of FIG. 1, except that the processing machine 300 of FIG. 9 also includes an inserting stage, following the mixing stage and prior to the solidifying stage, where the chopped, ground or milled foodstuffs, are placed in an assembled generally cylindrical enclosure portion 138 of dispensing package 128. The assembled generally cylindrical enclosure portion 138 preferably includes top cover portion 130, axial screw element 143, O-ring 272 and piston element 140. In a preferred embodiment, the chopped, ground or milled foodstuffs are in a liquid state following the mixing stage and the inserting stage includes pouring the liquid into the assembled generally cylindrical enclosure portion 138.

In the embodiment of FIG. 9, preferably, following the solidifying stage, shaving element 170, cutting element 176 and screw rotation portion 180 are then placed onto the filled, assembled generally cylindrical enclosure portion 138 of dispensing package 128. In another preferred embodiment, shaving element 170, cutting element 176 and screw rotation portion 180 are placed onto the filled, assembled generally cylindrical enclosure portion 138 of dispensing package 128 following the inserting stage and prior to the solidifying stage.

In a preferred embodiment of FIG. 9, the solidifying stage includes a freezing stage wherein the mixed foodstuffs and preserving binder are frozen in the dispensing package 128 in the form of cylinder 120.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A packaged edible comprising:
a generally cylindrical body of a foodstuff mixed with a binder in a generally solid form and arranged about a longitudinal axis; and
a dispensing package generally enclosing said generally cylindrical body of a foodstuff mixed with a binder in a generally solid form, said dispensing package including:
a first hand engageable enclosure portion generally surrounding said generally cylindrical body of a foodstuff mixed with a binder in a generally solid form;
a shaving element arranged to rotate about said longitudinal axis; and
a second hand engageable element arranged for manual rotation about said longitudinal axis and arranged to rotate said shaving element about said longitudinal axis in operative engagement with said generally cylindrical body of a foodstuff mixed with a binder in a generally solid form for shaving a surface thereof.

2. A packaged edible according to claim 1 and wherein said dispensing package also comprises a piston assembly including an axial screw element and a piston, said axial screw element being rotated by rotation of said second hand engageable element about said longitudinal axis and thereby producing axial movement of said piston along said longitudinal axis to force said generally cylindrical body of a foodstuff mixed with a binder in a generally solid form into said operative engagement with said shaving element.

3. A packaged edible according to claim 1 and wherein said foodstuff mixed with a binder in a generally solid form includes at least one of a vegetable, a spice and an herb.

4. A packaged edible according to claim 1 and wherein said foodstuff mixed with a binder in a generally solid form includes olive oil.

5. A packaged edible according to claim 1 and wherein said foodstuff mixed with a binder in a generally solid form includes a foodstuff mixed with a binder in a frozen state.

6. A method of producing a packaged edible comprising:
forming particles of a foodstuff into a generally cylindrical body of a foodstuff mixed with a binder in a generally solid form and arranged about a longitudinal axis; and
enclosing said generally cylindrical body of a foodstuff mixed with a binder in a generally solid form in a dispensing package including:
a first hand engageable enclosure portion generally surrounding said generally cylindrical body of a foodstuff mixed with a binder in a generally solid form;
a shaving element arranged to rotate about said longitudinal axis; and
a second hand engageable element arranged for manual rotation about said longitudinal axis and arranged to rotate said shaving element about said longitudinal axis in operative engagement with said generally cylindrical body of a foodstuff mixed with a binder in a generally solid form for shaving a surface thereof.

7. A method according to claim 6 and wherein said forming and said enclosing comprises filling said dispensing package with a foodstuff mixed with a binder in a non-solid form and solidifying said foodstuff mixed with a binder in a non-solid form.

8. A method according to claim 7 and wherein said solidifying comprises freezing said foodstuff mixed with a binder in a non-solid form.

9. A method according to claim 6 and also comprising, prior to said forming:
providing unprocessed foodstuffs;
washing said foodstuffs;
thereafter at least one of chopping said foodstuffs, grinding said foodstuffs and milling said foodstuffs; and
thereafter mixing said foodstuffs with a preserving binder.

10. A method according to claim 9 and wherein said foodstuffs include at least one of a vegetable, a spice and an herb.

11. A method according to claim 9 and wherein said preserving binder includes olive oil.

12. A method of producing a packaged edible comprising:
mixing particles of at least one foodstuff with a binder in a generally liquid form to produce a generally liquid mixture;
inserting said generally liquid mixture in a dispensing package arranged about a longitudinal axis, said dispensing package including:
a first hand engageable enclosure portion generally enclosing said generally liquid mixture;
a shaving element arranged to rotate about said longitudinal axis; and
a second hand engageable element arranged for manual rotation about said longitudinal axis and arranged to rotate said shaving element about said longitudinal axis; and
solidifying said generally liquid mixture to produce a generally solid mixture,
said shaving element being arranged to shave a surface of said generally solid mixture when rotated in operative engagement with said generally solid mixture.

13. A method according to claim 12 and wherein said solidifying comprises freezing said generally liquid mixture.

14. A method according to claim 12 and also comprising, prior to said mixing:
providing unprocessed foodstuffs;
washing said foodstuffs; and
thereafter at least one of chopping said foodstuffs, grinding said foodstuffs and milling said foodstuffs.

15. A method according to claim 12 and wherein said at least one foodstuff includes at least one of a vegetable, a spice and an herb.

16. A method according to claim 12 and wherein said preserving binder includes olive oil.

17. A method of producing a packaged edible comprising:
mixing particles of at least one foodstuff with a binder in a generally liquid form to produce a generally liquid mixture;
inserting said generally liquid mixture in a first hand engageable enclosure portion of a dispensing package arranged about a longitudinal axis;
solidifying said generally liquid mixture to produce a generally solid mixture;
placing a shaving element arranged to rotate about said longitudinal axis onto said first hand engageable enclosure portion; and
placing a second hand engageable element arranged for manual rotation about said longitudinal axis and arranged to rotate said shaving element about said longitudinal axis,
said shaving element being arranged to shave a surface of said generally solid mixture when rotated in operative engagement with said generally solid mixture.
